(19) United States
(12) Patent Application Publication
(10) Pub. No.: US 2025/0365343 A1
(43) Pub. Date: Nov. 27, 2025

(54) SWITCH TRIGGERED FASTER GO-BACK-N RECOVERY

(71) Applicant: Cisco Technology, Inc., San Jose, CA (US)

(72) Inventor: Harsha Bharadwaj, BANGALORE (IN)

(21) Appl. No.: 18/674,671

(22) Filed: May 24, 2024

(51) Int. Cl. H04L 67/1095; H04L 67/1097

(52) U.S. Cl. CPC H04L 67/1095; H04L 67/1097

(57) ABSTRACT

Devices, systems, methods, and processes for switch triggered faster go-back-N recovery are described herein. Typically, Go-back-N recovery is triggered in response to: a receiver missing a packet and receiving a next packet in a data transmission sequence, or a sender timing out and identifying a missing acknowledgement for a dropped packet. Such scheme suffers potential latency issues, especially when the dropped packet is the last packet or corresponds to a single packet message. Thus, instead of relying on the sender to timeout and identify missing acknowledgements or on the receiver to receive the next packet, a switch executes a packet mirroring and trimming scheme on the dropped packet and generates a trimmed out-of-order packet of the same reliable connection flow. The trimmed out-of-order packet causes the receiver to transmit a negative acknowledgement to the sender, thus triggering faster go-back-N recovery and causing the sender to retransmit the dropped packet.

The present disclosure relates to communications. More particularly, the present disclosure relates to triggering a faster go-back-N recovery at a switch.

### BACKGROUND

In the realm of high-performance computing, Remote Direct Memory Access (RDMA) over Converged Ethernet version 2 (RoCEv2) has emerged as a pivotal protocol facilitating fast communication between graphics processing units (GPUs). At its core, RDMA enables direct memory access between GPU memories, bypassing the operating system, thus enabling high-speed and low-latency communication. However, to maintain the integrity of data transmission, strict ordered delivery of packets is imperative.

RoCEv2 supports a Reliable Connection (RC) mode that employs Packet Sequence Numbers (PSNs) to meticulously track packet order. PSN is a monotonically increasing number that is used to mark the packet order by a sender. An acknowledgement (ACK) response or a negative acknowledgement (NACK) response is used by a receiver for acknowledging packet delivery to the sender.

When the receiver receives an unexpected packet (e.g., an out-of-order packet), the receiver discards the unexpected packet and requests a retransmission from the sender. Typically, the receiver detects that a packet is missing upon receiving a next packet from the sender. Thus, in scenarios where the missing packet signifies an end of a data transmission or consists of a single packet, the receiver may be unable to detect that a packet is missing as there is no next packet and may not request packet retransmission. Additionally, the sender might not know to retransmit until the sender times out and identifies a missing ACK response from the receiver for the missing packet. Although relying on the sender to timeout and identify missing acknowledgements serves as a failsafe solution, it adds another layer of complexity and exacerbates the potential for latency in completing data transfers.

### SUMMARY OF THE DISCLOSURE

Systems and methods for switch triggered faster go-back-N recovery in accordance with embodiments of the disclosure are described herein. In many embodiments, a device includes a processor, a network interface controller configured to provide access to a network, and a memory communicatively coupled to the processor. The memory includes a go-back-N recovery trigger logic that is configured to detect a packet drop event for an incoming packet. The go-back-N recovery trigger logic is configured to mirror the incoming packet in response to detecting the packet drop event to obtain a mirrored packet, modify a sequence number of the mirrored packet, and transmit the mirrored packet having the modified sequence number to a network device.

In a variety of embodiments, the go-back-N recovery trigger logic is further configured to trim a payload from the mirrored packet.

In a number of embodiments, the payload is trimmed prior to transmitting the mirrored packet to the network device.

In still more embodiments, one or more headers of the incoming packet are retained in the mirrored packet.

In additional embodiments, modifying the sequence number of the mirrored packet includes incrementing the sequence number.

In more embodiments, the mirrored packet having the modified sequence number is configured to trigger an out-of-order packet event at the network device.

In various embodiments, the go-back-N recovery trigger logic is further configured to associate a high priority traffic class with the mirrored packet prior to transmitting the mirrored packet to the network device.

In numerous embodiments, the high priority traffic class is configured to prioritize the transmission of the mirrored packet over transmission of one or more normal packets to the network device.

In numerous additional embodiments, the go-back-N recovery trigger logic is further configured to determine whether the incoming packet corresponds to a sequence number based Remote Direct Memory Access (RDMA) protocol.

In more embodiments, the go-back-N recovery trigger logic determines whether the incoming packet corresponds to the sequence number based RDMA protocol based on a destination port number of the incoming packet.

In still more embodiments, the go-back-N recovery trigger logic determines whether the incoming packet corresponds to the sequence number based RDMA protocol based on one or more headers of the incoming packet.

In further embodiments, at least one of the one or more headers includes a transport header.

In yet more embodiments, the go-back-N recovery trigger logic determines whether the incoming packet corresponds to the sequence number based RDMA protocol based on an opcode field included in the transport header.

In still yet more embodiments, the go-back-N recovery trigger logic mirrors the incoming packet, modifies the sequence number of the mirrored packet, and transmits the mirrored packet having the modified sequence number to the network device in response to determining that the incoming packet corresponds to the sequence number based RDMA protocol.

In many further embodiments, a device includes a processor, a network interface controller configured to provide access to a network, and a memory communicatively coupled to the processor. The memory includes a go-back-N recovery trigger logic that is configured to receive a trimmed packet, compare a sequence number associated with the trimmed packet with an expected sequence number, and detect an out-of-order packet event in response to a mismatch between the sequence number associated with the trimmed packet and the expected sequence number.

In many additional embodiments, the go-back-N recovery trigger logic is further configured to transmit, to a network device, a negative acknowledgement in response to detecting the out-of-order packet event.

In still yet further embodiments, the negative acknowledgement includes the expected sequence number.

In still yet additional embodiments, the negative acknowledgement is further configured to trigger a Go-back-N recovery event at the network device.

In several embodiments, the trimmed packet is a mirror of a dropped packet with the sequence number being different from a sequence number of the dropped packet.

In several more embodiments, a method for packet retransmission includes detecting a packet drop event for an incoming packet, mirroring the incoming packet in response to detecting the packet drop event to obtain a mirrored packet, modifying a sequence number of the mirrored packet, and transmitting the mirrored packet having the modified sequence number to a network device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a block diagram of an example network system in accordance with various embodiments of the disclosure;

FIG. 2 is a process flow diagram showing an example scenario where faster go-back-N recovery is triggered based on a packet trimming and mirroring scheme implemented at a switch in accordance with various embodiments of the disclosure;

FIG. 3 is a schematic block diagram of an example Remote Direct Memory Access (RDMA) over Converged Ethernet (RoCE) Reliable Connection (RC) packet format in accordance with various embodiments of the disclosure;

FIG. 4 is a conceptual schematic diagram of a logical view of packet sequence number (PSN) management at a sending device in accordance with various embodiments of the disclosure;

FIG. 5 is a conceptual schematic diagram of a logical view of PSN management at a receiving device in accordance with various embodiments of the disclosure;

FIG. 6 is a flowchart showing a process for switch triggered faster go-back-N recovery in accordance with various embodiments of the disclosure;

FIG. 7 is a flowchart showing a process for switch triggered faster go-back-N recovery in accordance with various embodiments of the disclosure;

FIG. 8 is a flowchart showing a process for triggering a go-back-N recovery event in accordance with various embodiments of the disclosure; and

FIG. 9 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that employ a packet mirroring and trimming scheme on a dropped packet at a switch to trigger faster go-back-N recovery (e.g., packet retransmission). In the realm of Artificial Intelligence (AI)/Machine learning (ML) workloads, handling large datasets and models, for example, Large Language Models (LLMs), presents a significant challenge. Offloading computations to multiple graphics processing units (GPUs) accelerates tasks, but often exceeds a single GPU's memory capacity. To address this concern, AI/ML frameworks distribute data and computations across multiple GPU nodes in clusters. High-performance AI data centers primarily depend on GPUs, necessitating efficient interconnection via a high-speed network. Remote Direct Memory Access (RDMA), originating from High Performance Community (HPC), is widely used in AI/ML clusters.

RDMA over Converged Ethernet version 2 (RoCEv2) has emerged as a pivotal protocol facilitating fast communication between GPUs. RDMA enables direct memory access between GPU memories, bypassing the operating system. Therefore, strict ordered delivery of packets is imperative for maintaining the integrity of data transmission. RoCEv2 supports a Reliable Connection (RC) mode that employs Packet Sequence Numbers (PSNs) to track packet order. A receiver can transmit an acknowledgement (ACK) response or a negative acknowledgement (NACK) response to acknowledge packet delivery to a sender. When the receiver receives an unexpected packet (e.g., an out-of-order packet), the receiver discards the unexpected packet, transmits a NACK response, and requests a retransmission from the sender. Since the receiver detects that a packet is missing upon receiving a next packet from the sender, packet retransmission might get delayed. For example, if the missing packet signifies the end of a data transmission or consists of a single packet, the receiver may be unable to detect the missing packet as there is no next packet. Further, in such scenarios, the sender might not know to retransmit until the sender times out and identifies the missing ACK response from the receiver. Such delayed packet retransmission increases the time for completion of the RDMA transfer and eventually results in longer job completion time, which is undesirable.

In many embodiments, a sending device may be communicatively coupled to a receiving device via a switch. The sending device transmits one or more packets to the switch and the switch forwards the received one or more packets to the receiving device. Each transmitted packet may be associated with a PSN. PSN is a monotonically increasing number that is used to mark packet order by the sending device. The receiving device, upon receiving a packet, verifies whether the received packet is correct, and accordingly acknowledges packet delivery to the sending device. For example, the receiving device may transmit, via the switch, an ACK response or a NACK response to the sending device to acknowledge the packet delivery. The ACK/NACK response may contain the same PSN as the corresponding packet being acknowledged. For example, an ACK PSN may indicate that all packets up to the ACK PSN were successfully delivered to the receiving device, whereas a NACK PSN may indicate that the packet with the NACK PSN had an error and request packet retransmission from the sending device.

In a number of embodiments, the switch may detect a packet drop event for an incoming packet. The incoming packet can be dropped for various reasons, for example, but not limited to, network congestion, buffer overflow, error detection, flow control, security policy violation, or the like. In response to detecting the packet drop event, the switch may execute a packet mirroring and trimming scheme on the to-be dropped packet to trigger faster go-back-N recovery. The switch may mirror the to-be dropped packet and obtain a mirrored packet. Initially, the mirrored packet may have the same PSN as the to-be dropped packet. In a variety of embodiments, the switch may trim a payload from the mirrored packet. During trimming, the switch may retain one or more headers of the to-be dropped packet in the mirrored packet. Further, the switch may modify the PSN of the mirrored packet. For example, the switch may increment the PSN of the mirrored packet to make mirrored packet PSN different from the PSN of the to-be dropped packet. In additional embodiments, the switch may drop the incoming packet and transmit the trimmed mirrored packet having the modified PSN to the receiving device. The mirrored packet having the modified PSN may be configured to trigger an out-of-order packet event at the receiving device.

In more embodiments, the switch may associate a high priority traffic class with the mirrored packet prior to transmitting the mirrored packet to the receiving device. The high priority traffic class may be configured to prioritize the transmission of the mirrored packet over transmission of one or more normal packets to the receiving device. Such prioritization ensures that the trimmed mirrored packets with modified PSN are delivered to the receiving device prior to normal data packets, resulting in faster triggering of the out-of-order packet event at the receiving device.

In additional embodiments, the switch may employ the above described packet mirroring and trimming scheme (e.g., mirroring the to-be dropped packet, trimming the payload, modifying the PSN, transmitting the mirrored packet, etc.) on those to-be dropped packets that are associated with a PSN based RDMA protocol, for example, a RoCEv2 RC protocol. Thus, prior to employing the packet mirroring and trimming scheme, the switch may determine whether a to-be dropped packet corresponds to any PSN based RDMA protocol. For example, the switch may check a destination port number and/or an opcode field included in a Base Transport Header (BTH) of the to-be dropped packet to determine whether the to-be dropped packet corresponds to the PSN based RDMA protocol, e.g., the RoCEv2 RC protocol.

In further embodiments, the receiving device may receive a trimmed packet. For example, the trimmed packet may be the trimmed mirrored packet with modified PSN transmitted by the switch corresponding to the dropped packet. In other words, the trimmed packet may be a mirror of the dropped packet with a sequence number being different from a sequence number of the dropped packet and with a payload being trimmed. In still more embodiments, the receiving device may compare a PSN of the trimmed packet with an expected PSN. In response to a mismatch between the PSN of the trimmed packet and the expected PSN, the receiving device may detect an out-of-order packet event and transmit a NACK response to the sending device via the switch. The NACK response may comprise the expected PSN and may trigger a go-back-N recovery event at the sending device, causing the sending device to retransmit all packets starting from the expected PSN (which is same as the PSN of the dropped packet).

The above described switch triggered faster go-back-N recovery scheme does not rely on the sending device to timeout to identify missing ACK responses from the receiving device or on the receiving device to receive an actual next packet in the data transmission sequence. Instead, the switch automatically generates an out-of-order packet (e.g., the trimmed mirrored packet with modified PSN) for an RC flow with a dropped packet and transmits the out-of-order packet to the receiving device, thus triggering a faster go-back-N recovery (e.g., packet retransmission) at the sending device.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in various embodiments, may alternatively be embodied by or implemented as a component.

A circuit, as used herein, comprises a set of one or more electrical and/or electronic components providing one or more pathways for electrical current. In numerous embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in various embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

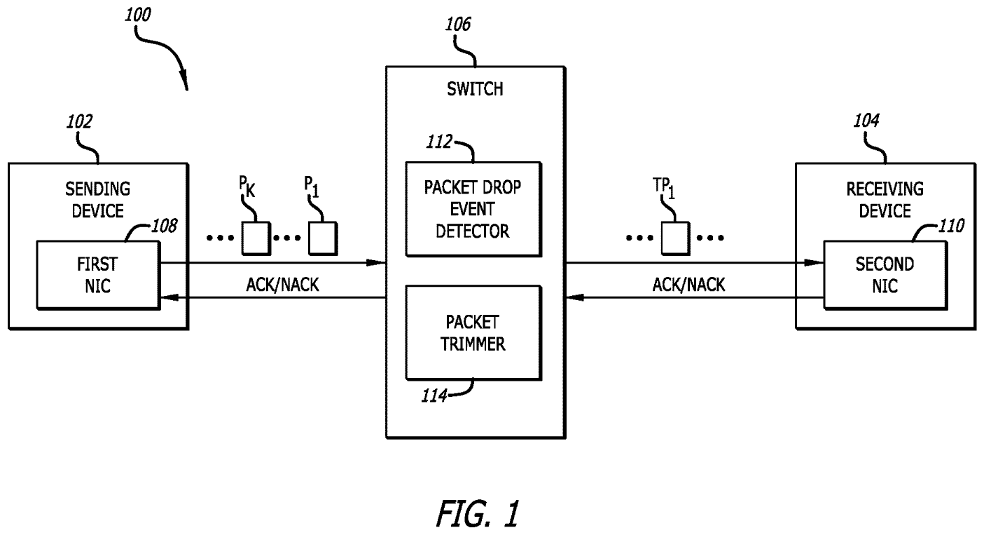

Referring to FIG. 1, a block diagram of an example network system 100 in accordance with various embodiments of the disclosure is shown. The network system 100 can utilize an InfiniBand (IB) fabric, Ethernet-based Remote Direct Memory Access (RDMA) network, leaf-Spine Architecture, Cloud network, or the like. The embodiments depicted in FIG. 1 may show a scenario where a sending device 102 is communicatively coupled to a receiving device 104 via a switch 106.

In many embodiments, the sending device 102 may be a network device that is capable of RDMA and is configured to initiate an RDMA data transfer process. Examples of the sending device 102 may include a graphics processing unit (GPU), a server, an Internet of Things (IoT) device, a mobile device, or the like. The sending device 102 may include a first network interface controller (NIC) 108. The first NIC 108 may include a gigabit Ethernet adapter or any similar component that may connect the sending device 102 to other devices, for example, the switch 106, over a network.

The first NIC 108 may be configured to segment data into one or more manageable units, for example, one or more packets P₁ . . . Pₖ (hereinafter, referred to as “packets P₁ . . . Pₖ”). Each packet P₁ . . . Pₖ may include a payload and one or more headers. Payload may include a segmented portion of the original data being transmitted. One or more headers may include essential information about the corresponding packet, for example, source and destination addresses, a packet sequence number (PSN), error checking information, an opcode field, protocol details, or the like. The source and destination addresses may include a source Internet Protocol (IP) address, a destination IP address, a source port number, and a destination port number.

In a number of embodiments, PSN may be a unique identifier assigned to each packet P₁ . . . P_{K} in a data transmission sequence. For example, when data is segmented into packets P₁ . . . P_{K} for transmission, each packet P₁ . . . P_{K} is assigned a unique PSN by the first NIC 108. In an example, PSNs can be monotonically increasing numbers. Thus, each subsequent packet is assigned a PSN that is greater than the PSN of the previous packet in the data transmission sequence. In other words, PSNs may serve as a means to maintain an order of packets P₁ . . . P_{K} and facilitate reliable communication between the sending device 102 and the receiving device 104.

In a variety of embodiments, the first NIC 108 may be configured to transmit the packets P₁ . . . P_{K} to the switch 106 for further routing towards a destination, for example, the receiving device 104. In additional embodiments, the first NIC 108 may utilize a PSN based RDMA protocol, for example, the RDMA over Converged Ethernet version 2 (RoCEv2) protocol, to transmit the packets P₁ . . . P_{K}. PSN based RDMA protocols, such as the RoCEv2 protocol, may utilize an adapted protocol stack with IB Layer 4 running on top of a User Datagram Protocol (UDP)/IP to provide reliable, ordered delivery of packets, for example, over Ethernet networks. A PSN based RDMA protocol can further employ a Reliable Connection (RC) mode to ensure strict ordering of packets for RDMA data transfers.

In additional embodiments, the first NIC 108 may be further configured to monitor the delivery of each packet P₁ . . . P_{K}. The first NIC 108 be configured to maintain a record of the highest PSN issued so far for a given RC flow. Further, the first NIC 108 may keep a track of acknowledgment (ACK) responses received from the receiving device 104 to validate successful packet delivery. An ACK response may include the same PSN as the corresponding packet being acknowledged by the receiving device 104. For each RC flow, the first NIC 108 may maintain a dynamic list of acknowledged PSNs, indicating which packets have been successfully received and processed by the receiving device 104, and a dynamic list of unacknowledged PSNs till the highest issued PSN, indicating which transmitted packets are yet to be acknowledged by the receiving device 104.

In more embodiments, the first NIC 108 may be configured to execute a go-back-N recovery scheme (e.g., packet retransmission) based on a negative ACK (NACK) response received from the receiving device 104. A NACK response may contain the same PSN as the corresponding packet being acknowledged by the receiving device 104. For example, a PSN in a NACK response may indicate that the packet with the PSN had an error and is required to be retransmitted along with all subsequent packets of the RC flow.

In additional embodiments, the receiving device 104 may be another RDMA-capable network device that functions as a recipient of the data transmitted by the sending device 102. Examples of the receiving device 104 may include a GPU, a server, an IoT device, a mobile device, or the like. The receiving device 104 may include a second NIC 110. The second NIC 110 may include a gigabit Ethernet adapter or any similar component that may connect the receiving device 104 to other devices, for example, the switch 106, over the network.

In numerous embodiments, the second NIC 110 may receive, via the switch 106, packets transmitted by the sending device 102. The second NIC 110 may be configured to utilize the received packets to reconstruct the original data. In further embodiments, upon receiving a packet, the second NIC 110 may examine one or more headers of the received packet to extract required information, for example, PSN, opcode, source and destination addresses, protocol details, or the like. The second NIC 110 may utilize the extracted PSN to determine whether the received packet is in correct order or is it an out-of-order packet. To determine whether the received packet is in the correct order, the second NIC 110 may compare the extracted PSN with an expected PSN. If the extracted PSN matches the expected PSN, the second NIC 110 determines that the received packet is in the correct order. However, if the extracted PSN does not match the expected PSN, the second NIC 110 determines that the received packet is an out-of-order packet and detects it as an out-of-order packet event.

In still more embodiments, in response to determining that the received packet is in the correct order, the second NIC 110 may generate an ACK response including the extracted PSN, and transmit the ACK response to the sending device 102 via the switch 106. Thus, acknowledging successful delivery and processing the received packet. However, in response to detecting the out-of-order packet event, the second NIC 110 may generate a NACK response including the expected PSN, and transmit the NACK response to the sending device 102 via the switch 106. The NACK response may be configured to trigger a go-back-N recovery event at the sending device 102, causing the first NIC 108 to retransmit the packet with the expected PSN along with all subsequent packets of the RC flow.

In still further embodiments, after transmitting a NACK response, the second NIC 110 may adopt a specific strategy to handle subsequent incoming packets until the second NIC 110 receives the packet with the expected PSN. In this strategy, the second NIC 110 may discard all subsequently received packets until the packet with the expected PSN is received. This deliberate discard ensures that any packet transmitted by the sending device 102 before receiving the NACK response is effectively disregarded by the second NIC 110, thus maintaining strict order delivery.

In still additional embodiments, the switch 106 may be another network device configured to execute packet routing by receiving the packets P₁ . . . P_{K} from the sending device 102 (e.g., the first NIC 108) and forwarding the packets P₁ . . . P_{K} to corresponding destinations, for example, the receiving device 104 (e.g., the second NIC 110) based on destination addresses included within the packets P₁ . . . P_{K}. The switch 106 may utilize a switching fabric to manage the flow of the packets P₁ . . . P_{K} through various switch ports. In more embodiments, the switch 106 may employ a packet buffering mechanism (e.g., a send/receive queue pair) to temporarily store incoming packets of an RC flow, for example, during times of congestion or high network traffic. The switch 106 can further support Quality of Service (QoS) features to prioritize certain types of traffic over others. For example, the switch 106 can associate a priority traffic class (e.g., a high priority traffic class, a medium priority traffic class, a low priority traffic class, etc.) with an incoming packet. Examples of the switch 106 may include an Ethernet switch, an IB switch, or the like.

In numerous embodiments, the switch 106 may include a packet drop event detector 112 configured to detect whether an incoming packet is to be dropped or forwarded to a corresponding destination. The packet drop event detector 112 can decide to drop an incoming packet (also referred to as to-be dropped packet) for various reasons, for example, but not limited to, network congestion, buffer overflow, error detection, flow control, security policy violation, or the like.

In yet more embodiments, the switch 106 may further include a packet trimmer 114. The packet trimmer 114 may be configured to implement a packet mirroring and trimming scheme on a to-be dropped packet to enable fast triggering of a go-back-N recovery event at the sending device 102. In several embodiments, the packet trimmer 114 may employ the packet mirroring and trimming scheme on those to-be dropped packets that are associated with any PSN based RDMA protocol, for example, RoCEv2 RC protocol. Thus, when the packet drop event detector 112 detects a packet drop event for an incoming packet, the packet trimmer 114 may determine whether the to-be dropped packet corresponds to a PSN based RDMA protocol (e.g., RoCEv2 RC protocol). The packet trimmer 114 may check a destination port number and/or one or more headers of the to-be dropped packet to determine whether the to-be dropped packet corresponds to the PSN based RDMA protocol (e.g., the RoCEv2 RC protocol).

In many examples, the packet trimmer 114 may check whether the destination port number of the to-be dropped packet is set to “4791”, an Internet Assigned Numbers Authority (IANA) designated port number for RoCEv2 RC traffic. In further examples, the packet trimmer 114 may check whether a transport header of the to-be dropped packet contains specific values in an opcode field. Generally, the opcode field comprises multiple bits (e.g., [7:0] bits), where bits [7:5] are used to denote an operation type (e.g., Send, Read, or Write) and bits [4:0] may specify a subtype of the operation, such as Send Only, Send First, Send Immediate, Send Last, Send Middle, or other variants. When the bits [7:5] in the opcode field contain values “000”, the packet trimmer 114 may determine that the to-be dropped packet is associated with the RoCEv2 RC protocol.

In response to detecting the packet drop event and that the to-be dropped packet is associated with the PSN based RDMA protocol (e.g., the RoCEv2 RC protocol), the packet trimmer 114 may be configured to implement the packet mirroring and trimming scheme. In still yet more embodiments, in the packet mirroring and trimming scheme, the packet trimmer 114 may mirror the to-be dropped packet and obtain a mirrored packet. For example, the packet trimmer 114 may utilize Serializer/Deserializer (SerDes) multiplexer, network taps, port mirroring/spanning techniques, or the like to mirror the to-be dropped packet. Initially, the mirrored packet may have the same PSN as the to-be dropped packet. The packet trimmer 114 may then trim a payload from the mirrored packet, while retaining one or more headers. In other words, after trimming, the mirrored packet may have the same one or more headers as the to-be dropped packet, without the payload. The packet trimmer 114 may modify the PSN of the mirrored packet to make mirrored packet PSN different from the PSN of the to-be dropped packet. More particularly, the packet trimmer 114 may increment the PSN of the mirrored packet. For example, if the PSN of the mirrored packet was ‘1’, after increment, the PSN of the mirrored packet can be, for example, ‘2’, ‘3’, or the like. The objective of the above packet mirroring and trimming scheme is to generate an out-of-order packet (e.g., a packet TP₁ shown in FIG. 1), for an RC flow that is associated with the to-be dropped packet, thus mimicking, for example, a RoCEv2 RC style error recovery.

In many further embodiments, the packet trimmer 114 may drop the incoming packet and transmit the trimmed mirrored packet having the modified PSN (e.g., the packet TP₁) to the receiving device 104. The trimmed mirrored packet (e.g., the packet TP₁) having the modified PSN may be configured to trigger an out-of-order packet event at the receiving device 104. For example, the second NIC 110 may be expecting to receive a packet with PSN “3”; however, when a trimmed packet with PSN “4” is received from the switch 106, the second NIC 110 may detect a mismatch with the expected PSN “3”. Thus, the receiving device 104 may detect the out-of-order packet event. Based on detection of the out-of-order packet event, the receiving device 104 (e.g., the second NIC 110) may transmit a NACK response, including the expected PSN, to the sending device 102. Such NACK response, when received by the sending device 102, may cause the first NIC 108 to execute go-back-N recovery (e.g., packet retransmission), for the given RC flow, starting from the expected PSN (which is the PSN included in the dropped packet).

In many additional embodiments, the packet trimmer 114 may associate the high priority traffic class with the trimmed mirrored packet (e.g., the packet TP₁) prior to transmitting the mirrored packet to the receiving device 104. The high priority traffic class may be configured to prioritize the transmission of the trimmed mirrored packet over transmission of one or more normal packets to the receiving device 104. For example, if there are multiple packets in a sending queue of the switch 106, the packet trimmer 114 may prioritize the transmission of packets associated with the high priority traffic class in comparison to packets associated with any lower priority traffic class. Such prioritization may ensure that the trimmed mirrored packets with modified PSN are delivered to the receiving device 104 prior to normal data packets, resulting in faster triggering of the out-of-order packet event at the receiving device 104, eventually reducing the time for triggering the go-back-N recovery event at the sending device 102.

In other words, the trimmed mirrored packet generated by the switch 106 triggers the out-of-order packet event at the receiving device 104, which in turn triggers the go-back-N recovery event at the sending device 102. In absence of such trimmed mirrored packet, the go-back-N recovery event can only be triggered if and when the receiving device 104 receives an actual subsequent packet to the dropped packet and transmits a NACK response or when the sending device 102 times out and identifies a missing ACK response for the dropped packet. In both these cases, the time taken to trigger a go-back-N recovery event at the sending device 102 is greater than the time it takes to trigger go-back-N recovery event based on the trimmed mirrored packet of the various embodiments of the disclosure. Additionally, no hardware modifications or additions are required at NIC level at the sending device 102, the receiving device 104, and the switch 106 to support the above described faster go-back-N recovery based on the packet trimming and mirroring scheme. Thus, making the faster go-back-N recovery easily compatible with existing network architecture.

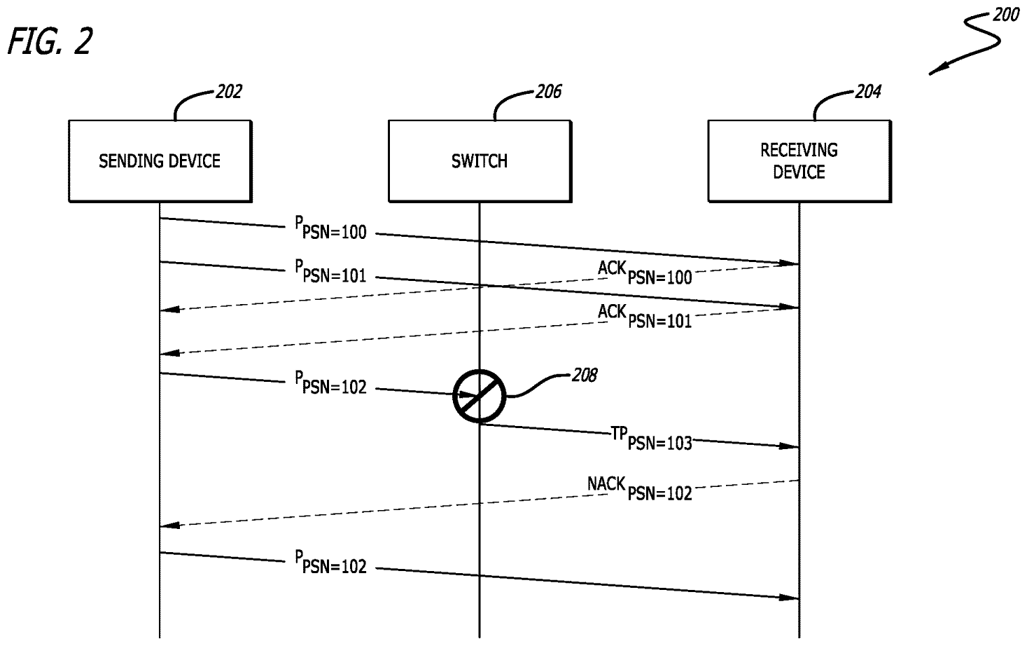

Although a specific embodiment of a network system suitable for carrying out the various steps, processes, methods, and operations described herein is discussed with respect to FIG. 1, any of a variety of systems and/or processes may be utilized in accordance with embodiments of the disclosure. For example, the switch 106 can transmit the mirrored packet with modified PSN without trimming the payload to the receiving device 104. The elements depicted in FIG. 1 may also be interchangeable with other elements of FIGS. 2-9 as required to realize a particularly desired embodiment.

Referring now to FIG. 2, a process flow diagram showing an example scenario 200 where faster go-back-N recovery is triggered based on a packet trimming and mirroring scheme implemented at a switch in accordance with various embodiments of the disclosure is shown. The embodiments depicted in FIG. 2 may show a scenario where a sending device 202 is communicatively coupled to a receiving device 204 via a switch 206. The switch 206 is capable of executing the packet trimming and mirroring scheme on a dropped packet to trigger faster go-back-N recovery at the sending device 202.

During an RDMA data transfer process, the sending device 202 may transmit one or more packets to the receiving device 204 via the switch 206. For example, as shown in FIG. 2, the sending device 202 transmits a first packet with (PSN=100) to the switch 206, the switch 206 forwards the first packet with (PSN=100) to the receiving device 204. In response to receiving any packet, the receiving device 204 may determine if the received packet is in the correct order. To determine whether the received packet is in the correct order, the receiving device 204 may compare a PSN of the received packet with an expected PSN. If the PSN of the received packet matches the expected PSN, the receiving device 204 determines that the received packet is in the correct order and transmits an ACK response including the PSN of the received packet to the sending device 202 via the switch 206. For example, as shown in FIG. 2, the receiving device 204 may determine that the first packet with (PSN=100) is in the correct order. Hence, the receiving device 204 transmits a first ACK with (PSN=100) to the switch 206, and the switch 206 forwards the first ACK with (PSN=100) to the sending device 202.

Likewise, the sending device 202 is further shown to transmit a second packet with (PSN=101) and a third packet with (PSN=102) to the switch 206 for forwarding to the receiving device 204. In the example scenario 200, the switch 206 forwards the second packet (PSN=101) to the receiving device 204, which in turn responds with a second ACK (PSN=101). However, the switch 206 detects some anomaly and decides to drop the third packet with (PSN=102). In FIG. 2, the packet drop event detected by the switch 206 is indicated by numeral 208. Upon detecting the packet drop event, the switch 206 may implement the packet mirroring and trimming scheme on the third packet (PSN=102) to obtain a mirrored trimmed packet with an incremented PSN=103. The switch 206 then forwards the mirrored trimmed packet (PSN=103) to the receiving device 204.

The receiving device 204, which was expecting to receive a packet with PSN=102, detects the mirrored trimmed packet (PSN=103) as an out-of-order packet and generates a NACK response including the expected PSN=102. The receiving device 204 then transmits the NACK (PSN=102) to the switch 206, which forwards the NACK (PSN=102) to the sending device 202. After sending the NACK (PSN=102), the receiving device 204 may discard all subsequently received packets, which can also include an actual packet with PSN=103, until a packet with the PSN=102 is received. The NACK (PSN=102) triggers a go-back-N recovery event at the sending device 202 and the sending device 202 retransmits the third packet with (PSN=102) along with all subsequent packets to the receiving device 204.

In absence of the packet mirroring and trimming scheme, the receiving device 204 can only detect the out-of-order packet event upon receiving a subsequent packet of the third packet, which would result in a delayed go-back-N recovery event at the sending device 202 in comparison to the present disclosure. Further, if there are no subsequent packets to the third packet, the receiving device 204 may fail to detect the out-of-order packet event. Consequently, the go-back-N recovery would only initiate when the sending device 202 times out and identifies a missing ACK response for the third packet, again resulting in a delayed go-back-N recovery event in comparison to the present disclosure. Therefore, the packet mirroring and trimming scheme executed by the switch 206 on the third packet (e.g., the dropped packet) as per the present disclosure causes a faster triggering of the go-back-N recovery event at the sending device 202.

Although a specific embodiment for the suitable for carrying out the various steps, processes, methods, and operations described herein is discussed with respect to FIG. 2, any of a variety of systems and/or processes may be utilized in accordance with embodiments of the disclosure. For example, the switch 206 can apply the trimming and PSN modification operations on the original dropped packet as well without the need to mirror the packet. The elements depicted in FIG. 2 may also be interchangeable with other elements of FIGS. 1 and 3-9 as required to realize a particularly desired embodiment.

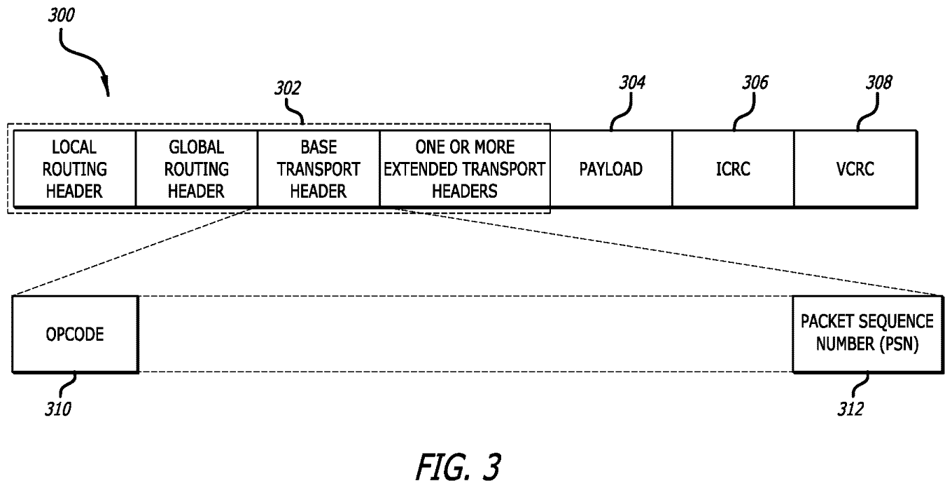

Referring to FIG. 3, a schematic block diagram of an example packet format in accordance with various embodiments of the disclosure is shown. The embodiments depicted in FIG. 3 may show a RoCEv2 RC packet format 300 of a packet transmitted by a sending device to a receiving device.

In many embodiments, the RoCEv2 RC packet format 300 may include one or more headers 302, a payload 304, invariant cyclic redundancy check (ICRC) 306, and a variant CRC (VCRC) 308. The one or more headers 302 may include a local routing header (LRH), a global routing header (GRH), a Base Transport Header (BTH), and other extended transport headers. The payload 304 may include a segmented portion of original data being transmitted. The ICRC 306 and the VCRC 308 may ensure data integrity and reliability within RoCEv2 RC packets.

In a number of embodiments, LRH is used for routing a packet within a subnet. The LRH may further include one or more fields for setting a priority traffic class of the packet to allow traffic prioritization within the subnet. In a variety of embodiments, GRH is responsible for routing a packet beyond the local subnet. GRH may also include one or more fields for traffic class, flow label, hop limit, and payload length, etc.

In a number of embodiments, BTH may serve as fundamental transport header and may encapsulate the payload 304. In an example, the BTH can be 12 bytes long. BTH may include critical information, for example, an opcode field 310 and a PSN 312. The opcode field 310 may specify a type of RDMA operation (e.g., Send, Read, or Write) that is to be performed with the packet. For example, the opcode field 310 may comprise multiple bits (e.g., [7:0] bits), where bits [7:5] are used to denote the operation type (e.g., Send, Read, or Write), and bits [4:0] are used to specify a subtype of the operation, such as Send Only, Send First, Send Immediate, Send Last, Send Middle, or other variants. In an example, the bits [7:5] in the Opcode field 310 contain values “000” to indicate RoCEv2 RC protocol. The PSN 312 may be configured to maintain packet order and facilitates reliable data transmission. The PSN 312 is a monotonically increasing number. For example, each subsequent packet is assigned a PSN that is greater than the PSN of the previous packet in data transmission sequence.

In a scenario, where a switch implements a packet mirroring and trimming scheme on a RoCEv2 RC packet to mimic a RoCEv2 RC style error recovery, the payload 304 can be trimmed and the PSN 312 can be incremented to generate an out-of-order packet. Further, the one or more headers 302 are retained. Further, the LRH or GRH may be updated to associate a high priority traffic class with the trimmed packet.

Although a specific embodiment for a RoCEv2 RC packet format suitable for carrying out the various steps, processes, methods, and operations described herein is discussed with respect to FIG. 3, any of a variety of systems and/or processes may be utilized in accordance with embodiments of the disclosure. For example, the switch can implement the packet mirroring and trimming scheme on any dropped packet that corresponds to a PSN based RDMA protocol for enabling faster go-back-N recovery at a sending device. The elements depicted in FIG. 3 may also be interchangeable with other elements of FIGS. 1, 2, and 4-9 as required to realize a particularly desired embodiment.

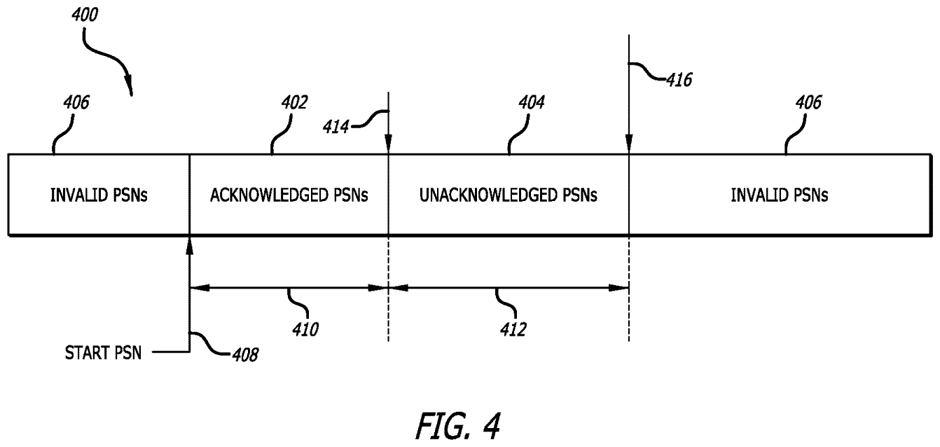

Referring to FIG. 4, a conceptual schematic diagram of a logical view 400 of PSN management at a sending device in accordance with various embodiments of the disclosure is shown. The embodiments depicted in FIG. 4 may show a scenario where the logical view 400 maintains a record of acknowledged PSNs 402, unacknowledged PSNs 404, and invalid PSNs 406. In many embodiments, the invalid PSNs 406 may be reserved for future use and are therefore considered invalid for allocation at current time instance.

In a variety of embodiments, the PSN management at the sending device may involve allocation of PSNs. For example, within a valid PSN range (e.g., excluding the invalid PSNs 406 from an available PSN range), the sending device may sequentially assign PSNs to individual packets destined for a specific RC flow, for example, starting from a PSN indicated by arrow 408 in FIG. 4. As packets are generated, the sending device may further maintain a record of the highest PSN issued so far for that RC flow.

In a number of embodiments, the PSN management at the sending device may further involve tracking of ACK/NACK responses for all assigned PSNs. For example, the sending device may maintain a dynamic list 410 of acknowledged PSNs, indicating which packets have been successfully received and processed at corresponding destinations. The sending device may further maintain another dynamic list 412 of unacknowledged PSNs, indicating which transmitted packets are yet to be acknowledged.

In numerous embodiments, as shown in the logical view 400, the sending device may utilize one or more pointers to track dynamic changes in the lists 410 and 412. In many examples, the sending device may utilize an acknowledged PSN pointer 414 that tracks the latest acknowledged PSN. Thus, the acknowledged PSN pointer 414 moves from a current PSN to a next PSN in response to receiving a new ACK response. In further examples, the sending device may utilize a highest issued PSN pointer 416 that tracks the highest PSN issued so far by the sending device. Thus, the highest issued PSN pointer 416 moves from a current PSN to a next PSN as a new packet is generated in the RC flow.

In additional embodiments, when the sending device receives a NACK response, the sending device may execute go-back-N recovery and retransmit packets staring from the PSN indicated by the acknowledged PSN pointer 414 till the highest issued PSN pointer 416 is reached. Thus, ensuring that all unacknowledged packets are retransmitted, maintaining the integrity and continuity of the data transmission.

Although a specific embodiment for a logical view of PSN management at a sending device suitable for carrying out the various steps, processes, methods, and operations described herein is discussed with respect to FIG. 4, any of a variety of systems and/or processes may be utilized in accordance with embodiments of the disclosure. For example, the sending device may further utilize a start PSN pointer that indicates a starting range of valid PSNs. The start PSN pointer may be a fixed pointer that only changes if there is a change in the starting range of valid PSNs. The elements depicted in FIG. 4 may also be interchangeable with other elements of FIGS. 1-3 and 5-9 as required to realize a particularly desired embodiment.

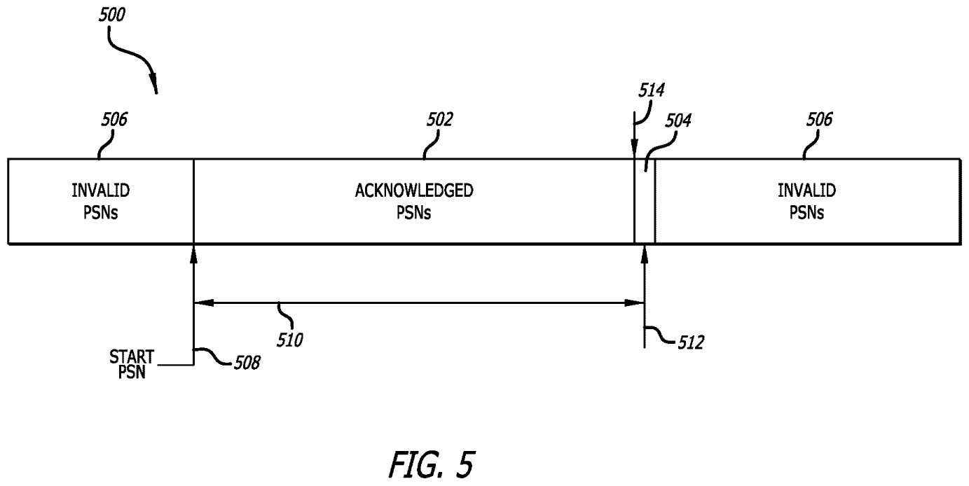

Referring to FIG. 5, a conceptual schematic diagram of a logical view 500 of PSN management at a receiving device in accordance with various embodiments of the disclosure is shown. The embodiments depicted in FIG. 5 may show a scenario where the logical view 500 maintains a record of acknowledged PSNs 502, an expected PSN 504, and invalid PSNs 506. In many embodiments, the invalid PSNs 506 may be reserved for future use and are therefore considered invalid at current time instance.

In a variety of embodiments, the PSN management at the receiving device may involve recording PSNs of acknowledged packets. Start of a valid PSN range is indicated by arrow 508 in FIG. 5. Initially, the expected PSN 504 may be the same as the start PSN indicated by the arrow 508. In additional embodiments, the receiving device may maintain a dynamic list 510 of acknowledged PSNs, indicating which packets have been successfully received and processed.

In various embodiments, as shown in the logical view 500, the receiving device may utilize one or more pointers to track dynamic changes in the list 510 and the expected PSN 504. In many examples, the receiving device may utilize an expected PSN pointer 512 that tracks the expected PSN 504 by the receiving device. In further examples, the receiving device may utilize an acknowledged PSN pointer 514 that tracks the latest acknowledged PSN. In numerous embodiments, the expected PSN pointer 512 points to a subsequent PSN than the PSN pointed to by the acknowledged PSN pointer 514.

In numerous embodiments, the sending device may compare a PSN of a received packet with the expected PSN 504. In a scenario where the PSN of the received packet matches the expected PSN 504, the receiving device generates and transmits an ACK response to acknowledge the successful delivery of the packet. In such a scenario, the expected PSN pointer 512 and the acknowledged PSN pointer 514 move from a current PSN to a next PSN. However, if the PSN of the received packet does not match the expected PSN 504, the receiving device generates and transmits a NACK response to acknowledge error in packet delivery. In such a scenario, the expected PSN pointer 512 and the acknowledged PSN pointer 514 do not move to the next PSN.

Although a specific embodiment for a logical view of PSN management at a receiving device suitable for carrying out the various steps, processes, methods, and operations described herein is discussed with respect to FIG. 5, any of a variety of systems and/or processes may be utilized in accordance with embodiments of the disclosure. For example, a receiving device may store the logical view 500 in a corresponding memory to ensure strict order packet delivery. The elements depicted in FIG. 5 may also be interchangeable with other elements of FIGS. 1-4 and 6-9 as required to realize a particularly desired embodiment.

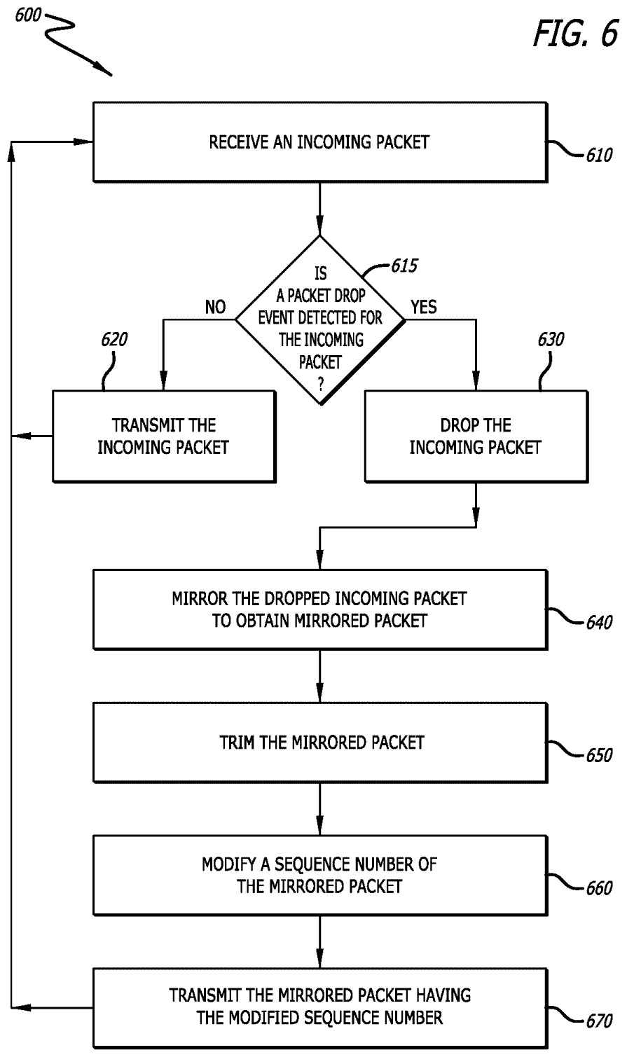

Referring to FIG. 6, a flowchart showing a process 600 for switch triggered faster go-back-N recovery in accordance with various embodiments of the disclosure is shown. In many embodiments, the process 600 may receive an incoming packet (block 610). The process 600 may receive the incoming packet from a sending device, for example, a GPU, a server, an IoT device, a mobile device, or the like. The incoming packet may include one or more headers and a payload. In a variety of embodiments, the one or more headers may include a sequence number (e.g., PSN) assigned to the incoming packet by the sending device. The sequence number may be a unique identifier assigned to the incoming packet in a data transmission sequence. In a number of embodiments, the incoming packet may belong to an RC flow and may be associated with a PSN based RDMA protocol, for example, the RoCEv2 RC protocol. In additional embodiments, the incoming packet can be a single packet, a last packet of a data transmission, or a middle packet of a data transmission.

In more embodiments, the process 600 may determine if a packet drop event is detected for the incoming packet (block 615). In additional embodiments, the process 600 may examine packet's destination Media Access Control (MAC) address and consult a forwarding table to determine an appropriate port to forward the incoming packet. However, if an issue is encountered during this process, a packet drop event might be detected. For example, a packet drop event can be detected for various reasons, for example, but not limited to, network congestion, buffer overflow, error detection, flow control, security policy violation, or the like.

In further embodiments, when the packet drop event is not detected for the incoming packet, the process 600 may transmit the incoming packet (block 620). The incoming packet may be forwarded to a corresponding destination (e.g., a receiving device). For example, the process 600 may forward the incoming packet to the receiving device through an appropriate port, for example, a port mapped to a MAC address of the receiving device. The process 600 may again receive a new incoming packet (block 610).

However, when the packet drop event is detected for the incoming packet, the process 600 may drop the incoming packet (block 630). Dropping the incoming packet indicates that the incoming packet is not forwarded to the corresponding destination. In still more embodiments, the process 600 may provide various logging and debugging options to enable a network administrator to diagnose a cause of packet drop. In some examples, the process 600 may log the packet drop event, providing the network administrator with a record of when and how the packet was dropped. In further examples, the process 600 may often maintain one or more counters that track various statistics, including a count of packets dropped.

In still further embodiments, the process 600 may mirror the dropped incoming packet to obtain a mirrored packet (block 640). For example, the process 600 may utilize Serializer/Deserializer (SerDes) multiplexer, network taps, port mirroring/spanning techniques, or the like to mirror the dropped incoming packet. In other words, the process 600 generates the mirrored packet based on the dropped incoming packet. Initially, the mirrored packet may have the same PSN as the dropped incoming packet.

In still additional embodiments, the process 600 may trim the mirrored packet (block 650). For example, the process 600 may trim the payload from the mirrored packet. Further, the process 600 may retain the one or more headers in the mirrored packet. Thus, after trimming, the mirrored packet may have the same one or more headers as the dropped packet, without the payload.

In more embodiments, the process 600 may modify a sequence number (e.g., the PSN) of the mirrored packet (block 660). In various embodiments, the process 600 may increment the sequence number of the mirrored packet. For example, if the sequence number of the mirrored packet is ‘101’, after increment, the sequence number of the mirrored packet can be, for example, ‘102’, ‘103’, or the like. The process 600 may modify the sequence number of the mirrored packet to generate an out-of-order packet for the RC flow.

In yet more embodiments, the process 600 may transmit the mirrored packet having the modified sequence number (block 670). For example, the process 600 may forward the mirrored packet having the modified sequence number to the receiving device. For example, the process 600 may forward the mirrored packet having the modified sequence number to the receiving device through an appropriate port, for example, a port mapped to the MAC address of the receiving device. Since the mirrored packet having the modified sequence number mimics an out-of-order packet for the RC flow, the mirrored packet may trigger an out-of-order packet event at the receiving device. The process 600 may again receive a new incoming packet (block 610).

Although a specific embodiment for switch triggered faster go-back-N recovery suitable for carrying out the various steps, processes, methods, and operations described herein is discussed with respect to FIG. 6, any of a variety of systems and/or processes may be utilized in accordance with embodiments of the disclosure. For example, the process 600 may prioritize the transmission of the mirrored packet having the modified sequence number over transmission of one or more normal packets. The elements depicted in FIG. 6 may also be interchangeable with other elements of FIGS. 1-5 and 7-9 as required to realize a particularly desired embodiment.

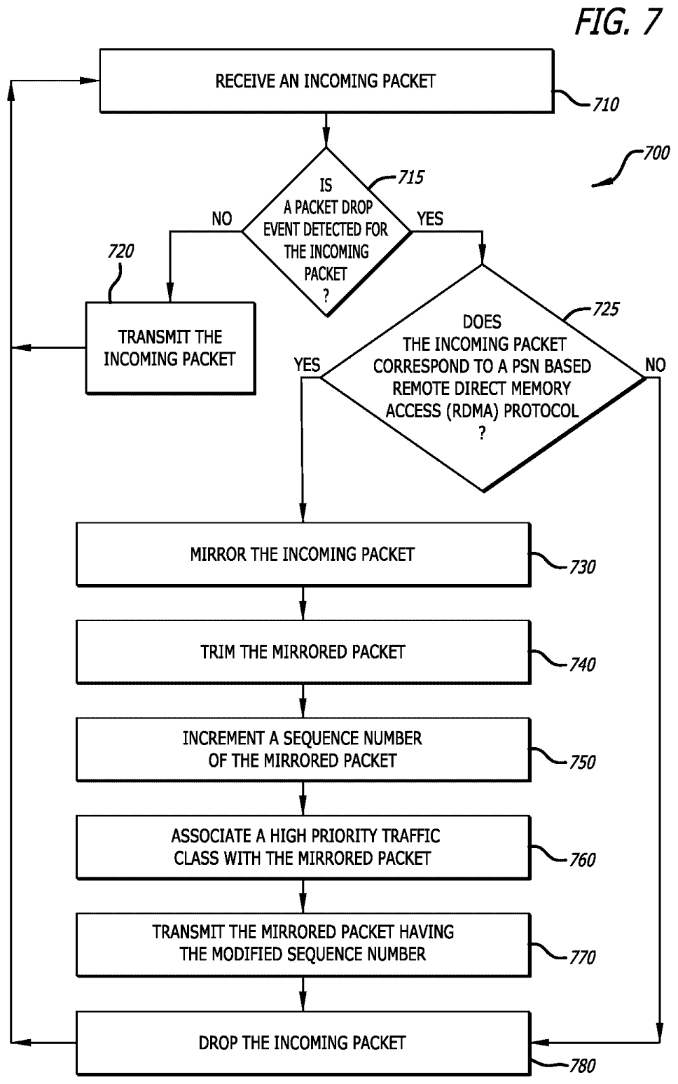

Referring to FIG. 7, a flowchart showing a process 700 for switch triggered faster go-back-N recovery in accordance with various embodiments of the disclosure is shown. In many embodiments, the process 700 may receive an incoming packet (block 710). The process 700 may receive the incoming packet from a sending device, for example, a GPU, a server, an IoT device, a mobile device, or the like. The incoming packet may include one or more headers and a payload. In a variety of embodiments, the one or more headers may include a sequence number (e.g., PSN) assigned to the incoming packet by the sending device. The sequence number may be a unique identifier assigned to the incoming packet in a data transmission sequence. In additional embodiments, the incoming packet can be a single packet, a last packet of a data transmission, or a middle packet of a data transmission.

In more embodiments, the process 700 may determine if a packet drop event is detected for the incoming packet (block 715). In additional embodiments, the process 700 may examine packet's destination MAC or IP address and consult a forwarding table to determine an appropriate port to forward the incoming packet. However, if an issue is encountered during this process, a packet drop event might be detected. For example, a packet drop event can be detected for various reasons, for example, but not limited to, network congestion, buffer overflow, error detection, flow control, security policy violation, or the like.

In further embodiments, when the packet drop event is not detected for the incoming packet, the process 700 may transmit the incoming packet (block 720). The incoming packet may be forwarded to a corresponding destination (e.g., a receiving device). For example, the process 700 may forward the incoming packet to the receiving device through an appropriate port, for example, a port mapped to a MAC address of the receiving device. The process 700 may again receive a new incoming packet (block 710).

However, when the packet drop event is detected for the incoming packet, the process 700 may determine if the incoming packet corresponds to a PSN based RDMA protocol (block 725). An example of the PSN based RDMA protocol may include the RoCEv2 RC protocol. RoCEv2 RC protocol is a network protocol that enables efficient data transfer between servers and storage devices over Ethernet networks. In numerous embodiments, the process 700 may check a destination port number and/or the one or more headers of the incoming packet to determine if the incoming packet corresponds to any PSN based RDMA protocol. In some examples, if the destination port number of the incoming packet is set to “4791”, an IANA designated port number for RoCEv2 RC traffic, the process 700 may determine that the incoming packet corresponds to the RoCEv2 RC protocol. In further examples, if a transport header of the incoming packet contains specific values (e.g., “000” in bits [7:5] of the opcode field), the process 700 may determine that the incoming packet corresponds to the RoCEv2 RC protocol.

In still more embodiments, when the incoming packet is determined to correspond to the PSN based RDMA protocol, the process 700 may mirror the incoming packet to obtain a mirrored packet (block 730). For example, the process 700 may utilize Serializer/Deserializer (SerDes) multiplexer, network taps, port mirroring/spanning techniques, or the like to mirror the incoming packet. Initially, the mirrored packet may have the same PSN as the incoming packet.

In still further embodiments, the process 700 may trim the mirrored packet (block 740). For example, the process 700 may trim the payload from the mirrored packet. Further, the process 700 may retain the one or more headers in the mirrored packet. Thus, after trimming, the mirrored packet may have the same one or more headers as the dropped packet, without the payload.

In more embodiments, the process 700 may increment the sequence number (e.g., the PSN) of the mirrored packet (block 750). For example, if the sequence number of the mirrored packet is ‘101’, after increment, the sequence number of the mirrored packet can be, for example, ‘102’, ‘103’, or the like. The process 700 may increment the sequence number of the mirrored packet to generate an out-of-order packet for the RC flow.

In various embodiments, the process 700 may associate the high priority traffic class with the mirrored packet (block 760). The high priority traffic class may be configured to prioritize a transmission of the mirrored packet over transmission of one or more normal packets. For example, if there are multiple packets in a sending queue, the transmission of the mirrored packet associated with the high priority traffic class may be prioritized over the transmission of packets associated with lower priority traffic classes.

In yet more embodiments, the process 700 may transmit the mirrored packet having the modified sequence number (block 770). For example, the process 700 may forward the mirrored packet having the modified sequence number to the receiving device. For example, the process 700 may forward the mirrored packet having the modified sequence number to the receiving device through an appropriate port, for example, a port mapped to the MAC address of the receiving device. In still yet more embodiments, if the mirrored packet is associated with the high priority traffic class, the mirrored packet may be transmitted prior to other packets associated with lower priority traffic classes. Since the mirrored packet having the modified sequence number mimics an out-of-order packet for the RC flow, the mirrored packet may trigger an out-of-order packet event at the receiving device.

In many further embodiments, the process 700 may drop the incoming packet (block 780). For example, when the incoming packet is not determined to correspond to the PSN based RDMA protocol, the process 700 may drop the incoming packet without implementing the packet mirroring and trimming scheme (block 730-block 770). However, when the incoming packet is determined to correspond to the PSN based RDMA protocol, the process 700 may drop the incoming packet and also implement the packet mirroring and trimming scheme (block 730-block 770). The process 700 may again receive a new incoming packet (block 710).

Although a specific embodiment for switch triggered faster go-back-N recovery suitable for carrying out the various steps, processes, methods, and operations described herein is discussed with respect to FIG. 7, any of a variety of systems and/or processes may be utilized in accordance with embodiments of the disclosure. For example, a switch may execute the packet mirroring and trimming scheme when a dropped packet is a single frame as part of a short message (e.g., single packet Send Only) or the last frame of a message (e.g., Send Last). In such scenarios, the switch may further determine whether the dropped packet is a single frame as part of a short message (e.g., single packet Send Only) or the last frame of a message (e.g., Send Last) based on the opcode field. The elements depicted in FIG. 7 may also be interchangeable with other elements of FIGS. 1-6, 8, and 9 as required to realize a particularly desired embodiment.

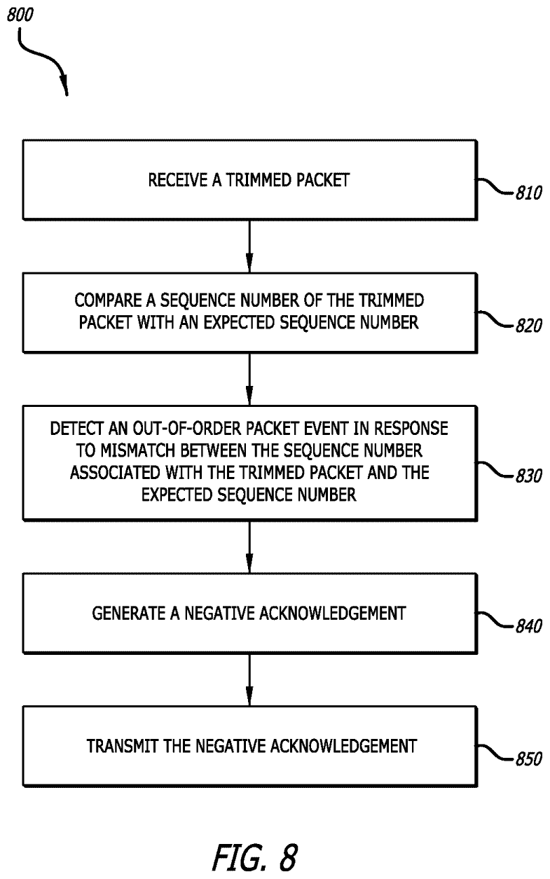

Referring to FIG. 8, a flowchart showing a process 800 for triggering a go-back-N recovery event in accordance with various embodiments of the disclosure is shown. In many embodiments, the process 800 may receive a trimmed packet (block 810). For example, the trimmed packet may correspond to a trimmed mirrored packet transmitted by a switch. In other words, the trimmed packet may be a mirror of a dropped packet with a sequence number (e.g., a PSN) being different from a sequence number of the dropped packet and with a payload being trimmed. One or more headers in the trimmed packet may be same as one or more headers of the dropped packet.

In a variety of embodiments, the process 800 may compare the sequence number of the trimmed packet with an expected sequence number (block 820). If a comparison result indicates that the sequence number of the trimmed packet is same as the expected sequence number, the process 800 may establish that the trimmed packet is in the correct order. However, if the comparison result indicates that the sequence number of the trimmed packet is different (for example, greater than) from the expected sequence number, the process 800 may establish that the trimmed packet is an out-of-order packet.

In a number of embodiments, the process 800 may detect an out-of-order packet event in response to a mismatch between the sequence number associated with the trimmed packet and the expected sequence number (block 830). In other words, the out-of-order packet event may be detected when an out-of-order packet is received. In additional embodiments, when the out-of-order packet event is detected for an RC flow, the expected sequence number is not incremented and the last acknowledged sequence number for the given RC flow also remains the same.

In various embodiments, the process 800 may generate a negative acknowledgement (block 840). The negative acknowledgement (e.g., NACK response) may include the expected sequence number, indicating that the corresponding packet had an error. The negative acknowledgement may be configured to trigger a go-back-N recovery event at a sending device associated with the trimmed packet.

In numerous embodiments, the process 800 may transmit the negative acknowledgement (block 850). The negative acknowledgement (e.g., NACK response) may be transmitted to the sending device, causing the sending device to retransmit all packets starting from the expected sequence number. As a result, the go-back-N recovery event at the sending device is triggered prior to the sender timing out.

Although a specific embodiment for triggering a go-back-N recovery event suitable for carrying out the various steps, processes, methods, and operations described herein is discussed with respect to FIG. 8, any of a variety of systems and/or processes may be utilized in accordance with embodiments of the disclosure. For example, the process 800 may discard all subsequently received packets of the RC flow, which can also include a genuine packet having the incremented PSN as of the trimmed packet, until a packet with the expected sequence number is received. The elements depicted in FIG. 8 may also be interchangeable with other elements of FIGS. 1-7 and 9 as required to realize a particularly desired embodiment.

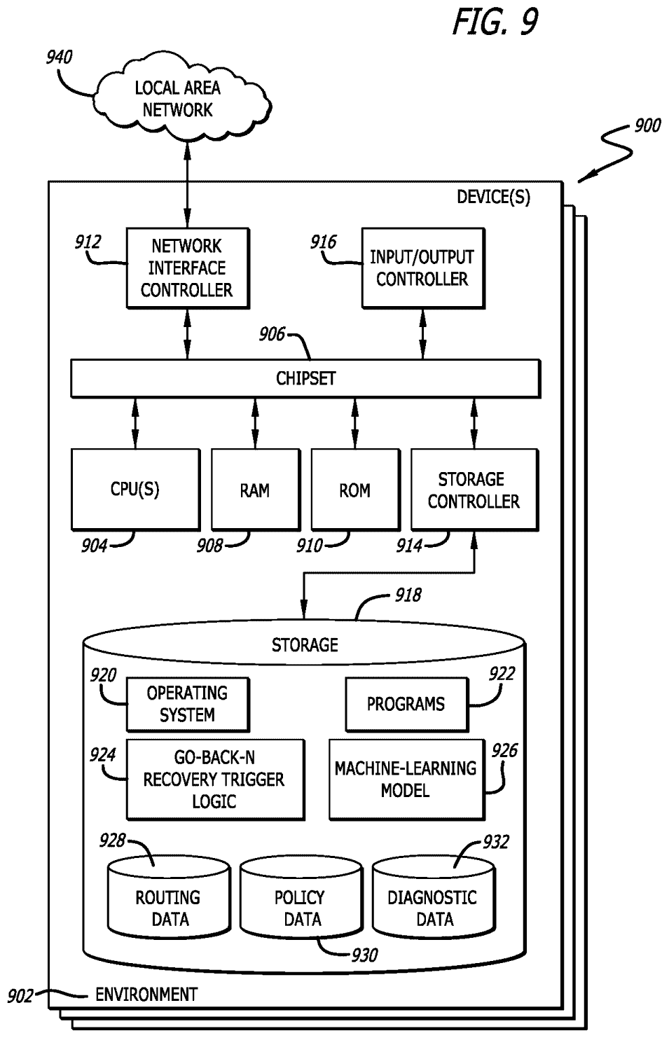

Referring to FIG. 9, a conceptual block diagram for one or more devices 900 capable of executing components and logic for implementing the functionality and embodiments described above is shown. The embodiment of the conceptual block diagram depicted in FIG. 9 can illustrate a conventional server computer, workstation, desktop computer, laptop, tablet, network appliance, e-reader, smartphone, or other computing device, and can be utilized to execute any of the application and/or logic components presented herein. The device 900 may, in some examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In additional embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in additional embodiments. The chipset 906 can further be configured to provide an interface to a computer-readable storage medium such as a read-only memory (“ROM”) 910 or non-volatile RAM (“NVRAM”) 908 for storing basic routines that can help with various tasks such as, but not limited to, starting up the device 900 and/or transferring information between the various components and devices. The ROM 910 or NVRAM 908 can also store other application components necessary for the operation of the device 900 in accordance with various embodiments described herein.

Different embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for example, store an operating system 920, applications 922, and data 928, 930, 932, which are described in greater detail below. The storage 918 can be connected to the environment 902 through a storage controller 914 connected to the chipset 906. In various embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In various embodiment, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In additional embodiments, the device 900 has access to computer-readable storage media storing computer-executable instructions which, when executed by the device 900, perform the various processes described above with regard to FIGS. 1-8. In more embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9, and can include other components that are not explicitly shown in FIG. 9, or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In many embodiments, the device 900 can include a go-back-N recovery trigger logic 924 that can be configured to perform one or more of the various steps, processes, operations, and/or other methods that are described above. Often, the go-back-N recovery trigger logic 924 can be a set of instructions stored within a non-volatile memory that, when executed by the processor(s)/controller(s) 904 can carry out these steps, etc. In additional embodiments, the go-back-N recovery trigger logic 924 may be a client application that resides on a network-connected device, such as, but not limited to, a server, switch, personal or mobile computing device, an access point (AP). In various embodiments, the go-back-N recovery trigger logic 924 can enable a packet mirroring and trimming scheme on dropped packets to enable faster triggering of go-back-N recovery.

In several embodiments, the go-back-N recovery trigger logic 924 can enable the device 900 (for example, a switch) to determine if a to-be dropped packet corresponds to any PSN based RDMA protocol, e.g., the RoCEv2 RC protocol. In numerous embodiments, the go-back-N recovery trigger logic 924 can enable the device 900 (e.g., the switch) to execute the packet mirroring and trimming scheme on a to-be dropped packet to generate an out-of-order packet (e.g., a trimmed mirrored packet with a modified PSN) for a given RC flow. The generated out-of-order packet can be sent to a destination device to trigger an out-of-order packet event at the destination, which eventually results in triggering a go-back-N recovery event at a source device. In numerous additional embodiments, the go-back-N recovery trigger logic 924 can enable the device 900 (e.g., a receiving device, a GPU, etc.) to detect an out-of-order packet event when a PSN of a trimmed packet does not match an expected PSN. In still more embodiments, the go-back-N recovery trigger logic 924 can enable the device 900 (e.g., a receiving device, a GPU, etc.) to generate and transmit a NACK response to the source device for triggering a go-back-N recovery event (e.g., for packet retransmission) at the source device.

In a number of embodiments, the storage 918 can include routing data 928. In additional embodiments, routing data 928 can include information, for example, routing tables. Routing table may contain various entries that map destination IP addresses to next hop or outgoing ports. Routing tables enable the device 900 in making packet forwarding decisions. MAC address table is an example of a routing table. MAC address table may include destination MAC addresses mapped to corresponding switch ports. The routing data 928 may further store a mapping between IP addresses and MAC addresses within a network. Such mapping may be utilized to translate IP addresses to MAC addresses for proper forwarding of packets.

In various embodiments, the storage 918 can include policy data 930. In several embodiments, the policy data 930 can comprise information regarding access control lists. Access control lists may delineate a sets of rules that determine what type of traffic is allowed or denied on the network. The set of rules can be based on various criteria such as source or destination IP addresses, port numbers, or communication protocols. In several more embodiments, the policy data 930 can include QoS policies. For example, QoS policies can be used to prioritize certain types of traffic (e.g., trimmed mirrored packets) over others to ensure that critical applications receive necessary latency requirements. In numerous additional embodiments, the policy data 930 can further include security policies, authentication and authorization policies, or the like.

In still more embodiments, the storage 918 can include diagnostic data 932. Diagnostic data 932 may include logging and debugging information that enables a network administrator to diagnose various causes of packet drops at the device 900. For example, the diagnostic data 932 may include logs of various packet drop events at the device 900, providing the network administrator with a record of when and how the packets were dropped. In further examples, the diagnostic data 932 may include one or more counters that track various statistics, including a count of packets dropped.

Finally, in many embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. The ML model 926 may be configured to learn various packet drop patterns and generate predictions as to when a packet is most likely to be dropped. Such predictions may further improve the speed of triggering go-back-N recovery events.

The ML model(s) 926 can be configured to generate inferences to make predictions or draw conclusions from data. An inference can be considered the output of a process of applying a model to new data. This can occur by learning from infrastructure data, sustainability data, and/or health data and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a go-back-N recovery trigger logic that is configured to:
detect a packet drop event for an incoming packet;
mirror the incoming packet in response to detecting the packet drop event to obtain a mirrored packet;
modify a sequence number of the mirrored packet; and
transmit the mirrored packet having the modified sequence number to a network device.

2. The device of claim 1, wherein the go-back-N recovery trigger logic is further configured to trim a payload from the mirrored packet.

3. The device of claim 2, wherein the payload is trimmed prior to transmitting the mirrored packet to the network device.

4. The device of claim 2, wherein one or more headers of the incoming packet are retained in the mirrored packet.

5. The device of claim 1, wherein modifying the sequence number of the mirrored packet comprises incrementing the sequence number.

6. The device of claim 1, wherein the mirrored packet having the modified sequence number is configured to trigger an out-of-order packet event at the network device.

7. The device of claim 1, wherein the go-back-N recovery trigger logic is further configured to associate a high priority traffic class with the mirrored packet prior to transmitting the mirrored packet to the network device.

8. The device of claim 7, wherein the high priority traffic class is configured to prioritize the transmission of the mirrored packet over transmission of one or more normal packets to the network device.

9. The device of claim 1, wherein the go-back-N recovery trigger logic is further configured to determine whether the incoming packet corresponds to a sequence number based Remote Direct Memory Access (RDMA) protocol.

10. The device of claim 9, wherein the go-back-N recovery trigger logic determines whether the incoming packet corresponds to the sequence number based RDMA protocol based on a destination port number of the incoming packet.

11. The device of claim 9, wherein the go-back-N recovery trigger logic determines whether the incoming packet corresponds to the sequence number based RDMA protocol based on one or more headers of the incoming packet.

12. The device of claim 11, wherein at least one of the one or more headers comprises a transport header.

13. The device of claim 12, wherein the go-back-N recovery trigger logic determines whether the incoming packet corresponds to the sequence number based RDMA protocol based on an opcode field included in the transport header.

14. The device of claim 9, wherein the go-back-N recovery trigger logic mirrors the incoming packet, modifies the sequence number of the mirrored packet, and transmits the mirrored packet having the modified sequence number to the network device in response to determining that the incoming packet corresponds to the sequence number based RDMA protocol.

15. A device, comprising:
a processor;
a network interface controller configured to provide access to a network; and
a memory communicatively coupled to the processor, wherein the memory comprises a go-back-N recovery trigger logic that is configured to:
receive a trimmed packet;
compare a sequence number associated with the trimmed packet with an expected sequence number; and
detect an out-of-order packet event in response to a mismatch between the sequence number associated with the trimmed packet and the expected sequence number.

16. The device of claim 15, wherein the go-back-N recovery trigger logic is further configured to transmit, to a network device, a negative acknowledgement in response to detecting the out-of-order packet event.

17. The device of claim 16, wherein the negative acknowledgement comprises the expected sequence number.

18. The device of claim 16, wherein the negative acknowledgement is further configured to trigger a Go-back-N recovery event at the network device.

19. The device of claim 15, wherein the trimmed packet is a mirror of a dropped packet with the sequence number being different from a sequence number of the dropped packet.

20. A method for packet retransmission, comprising:
detecting a packet drop event for an incoming packet;
mirroring the incoming packet in response to detecting the packet drop event to obtain a mirrored packet;
modifying a sequence number of the mirrored packet; and
transmitting the mirrored packet having the modified sequence number to a network device.
